(19) United States
(12) Patent Application Publication
(10) Pub. No.: US 2008/0228662 A1
(43) Pub. Date: Sep. 18, 2008

(54) System and method for facilitating the funding and administration of a long term investment or retirement trust for yet-to-be-born individuals

(76) Inventors: Glen Armand, Warrenton, VA (US); Lawrence J. Eisenberg, Gaithersburg, MD (US)

Correspondence Address: WILLIAMS MULLEN, 222 CENTRAL PARK AVENUE, SUITE 1700, VIRGINIA BEACH, VA, 23462, US

(21) Appl. No.: 11/890,618

(22) Filed: Aug. 7, 2007

Related U.S. Application Data
(63) Continuation-in-part of application No. 11/724,351, filed on Mar. 15, 2007.

(51) Int. Cl. G06Q 40/00

(52) U.S. Cl. 705/36 R

(57) ABSTRACT

The funding and administration of a long term investment and/or retirement trust for yet-to-be born individuals are facilitated by the present invention. In one embodiment, the present invention provides a system and method for the input of user variables specific to the requirements necessary for the real-time production of trust documents necessary and specific to the purpose of establishing a funded pre-retirement trust for a yet-to-be born individual.

### REFERENCE TO RELATED APPLICATIONS

This application is a continuation-in-part application of U.S. application Ser. No. 11/724,351 filed Mar. 15, 2007 and entitled “System and Method for Facilitating the Funding and Administration of a Long Term Investment or Retirement Trust.”

### FIELD OF THE INVENTION

The present invention relates to investment vehicles and more particularly to facilitating the funding and administration of a long term investment and/or retirement trust on behalf of as-yet unborn individuals.

### BACKGROUND OF THE INVENTION

Various investment vehicles exist which allow individuals to save for certain future expenses or life events while enjoying certain beneficial tax treatment. College savings plans, retirement plans, trusts and annuities are examples of such vehicles.

Regarding retirement plans, the present age is witnessing a shift in how investment plans are established, as many company pension (i.e., defined benefit) plans are being replaced with defined contribution plans (e.g., 401(k) plans, individual retirement accounts (IRAs), SEP IRAs). Further, many individuals today are operating under the assumption that they may never see their Social Security benefits. As a result, people are less certain about how much money they can count on in their later years, and it is possible and unfortunate that many retirees will outlive their retirement savings.

The financial planning industry promotes many products, systems, books and tapes that educate individuals on how to safely set aside funds for use and enjoyment during the retirement years. However, there are no systems or products in place for funding and administering a long term investment and/or retirement trust for yet-to-be-born people in accordance with the present invention.

### SUMMARY OF THE INVENTION

The present invention provides a system and method for facilitating the funding and administration of a long term investment and/or retirement trust for as-yet unborn individuals. In one embodiment, the present invention provides a system and method for the input of user variables specific to the requirements necessary for the real-time production of investment account documents and future trust documents necessary and specific to the purpose of establishing a funded pre-retirement trust for a yet-to-be-born individual.

### BRIEF DESCRIPTION OF THE DRAWINGS

FIG. 1 is an exemplary schematic representation of one embodiment of the system of the present invention.

FIG. 2 is a sample interface for use in determining various investment options in accordance with the present invention.

FIG. 3 shows a sample graphical illustration associated with an investment evaluation in accordance with the present invention.

FIG. 4 shows a sample flow chart illustrating method steps in accordance with investment modeling aspects of the present invention.

FIG. 5 shows a sample flow chart illustrating method steps in accordance with trust generation aspects of the present invention.

FIGS. 6 through 11 are sample interface displays associated with one embodiment of the investment modeling component of the present invention.

### DETAILED DESCRIPTION OF THE PREFERRED EMBODIMENTS

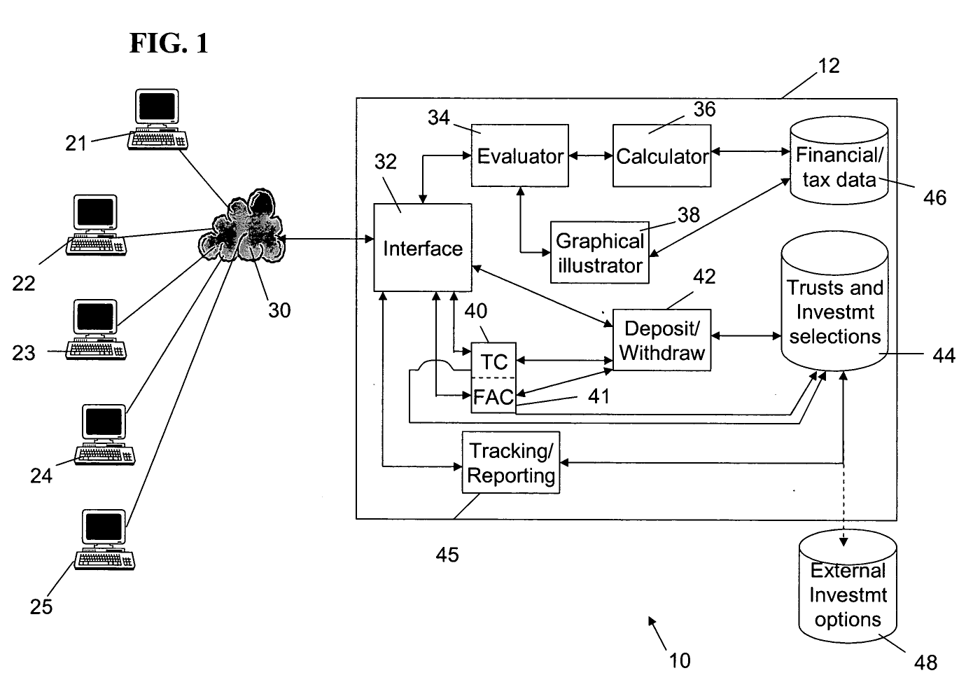

As shown in FIGS. 1 through 5, there is provided a system 10 including an investment modeling and management system 12 connected by network 30 to various user systems 21-25. The user systems can be, for example, a grantor's computer system 21, a beneficiary's computer system 22, a trustee's computer system 23, an administrator's computer system 24 and an employer's computer system 25.

Within investment modeling and management system 12, there are provided various components that assist in carrying out the functions of the present invention. Interface component 32 provides a filter for allowing the various user systems 21-25 to interact with appropriate other components according to the user type, beneficiary age and status, and security measures as described more completely herein. Evaluator component 34 provides graphical user interfaces to help a user such as a grantor decide which investment option to use. For example, the system can provide the calculation and comparative graphical relationship representation of a level of funding made by the grantor to projected funding requirements to fulfill a specified target lump sum benefit or target annuitized benefit. Evaluator component can interact with calculator 36 and graphical illustrator 38, which have access to financial database 46 in performing their functions.

One aspect of evaluator component 34 provides user interfaces for receiving details about different user types. For example, with a grantor, the evaluator component can receive name, address, e-mail, telephone, and social security number (collectively, “identification data”). In assisting a grantor with investment decisions, the evaluator component can provide a user interface that receives possible terms for the investment, as well as possible investment structures. The investment terms can be, for example, (1) the amount of a targeted lump sum benefit (in today's dollars) desired, (2) the amount of a targeted annual annuity benefit (in today's dollars) desired, (3) the amount of a targeted monthly annuity benefit (in today's dollars) desired, (4) the current Social Security Income Benefit, (5) the average Social Security Income Benefit Cost of Living Adjustment, (6) the projected future Social Security Income Benefit, (7) the number of benefit periods desired (maximum of one), (8) the age at funding, (9) the amount of lump sum contributions, (10) the amount of additional contributions, (11) the number of additional funding contributions, (12) the pre-retirement interest rate assumption, (13) the post retirement interest assumption, and (14) the targeted age of the beneficiary's retirement age. The terms can also include, for example, whether the investment will be a retirement account, a retirement trust or other investment vehicle. It will be appreciated that not all of the investment terms will be required to be received by the evaluator component of the present invention before the evaluator can provide analysis, particularly given that the trust and/or account will be for the current or ultimate benefit of a yet-to-be-born individual.

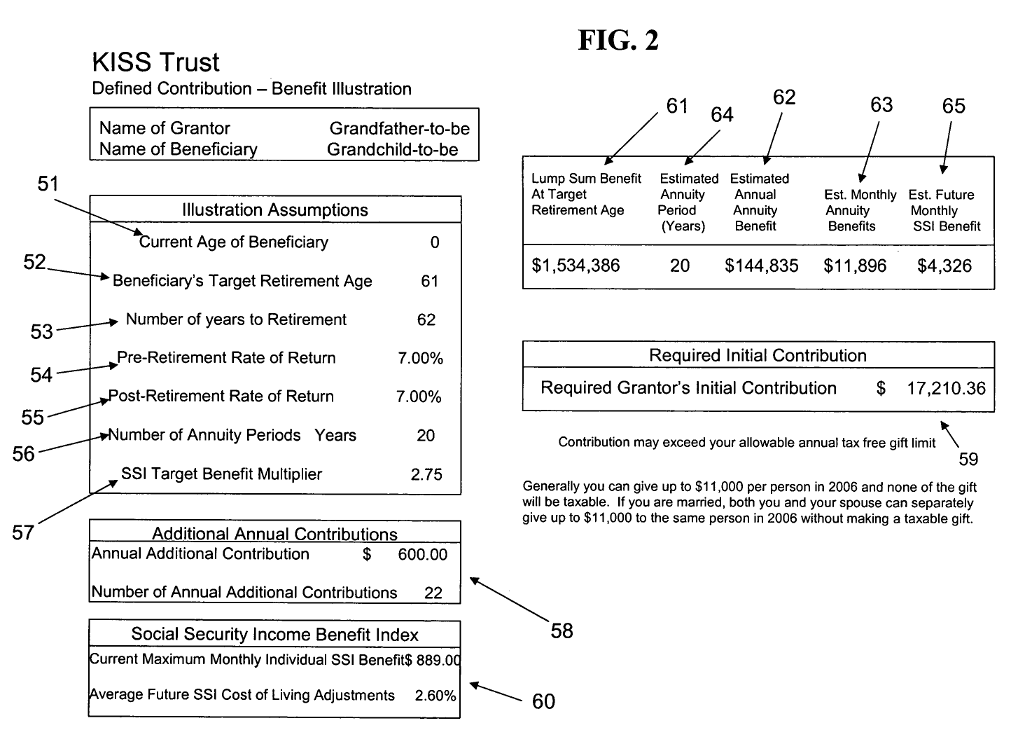

Once evaluator component 34 has received the user input, it can present the input to calculator component 36 and graphical illustrator component 38. Upon receiving the information from evaluator component 34, calculator component 36 can calculate the available investment opportunities with the optional assistance of data from financial database 46. For example, if the grantor is seeking to determine what defined benefit would result from a particular defined contribution for a yet-to-be born individual (e.g., an expected newborn baby) beginning when the individual retires at age sixty-one, the grantor or a representative would input information as shown in FIG. 2. This inputted information can be represented as assumptions: the current age of the beneficiary as at 51 (which can be “0” or a negative number for yet-to-be-born individuals), the beneficiary's target retirement age as at 52, the number of years to retirement as at 53, the pre-retirement rate of return as at 54, the post-retirement rate of return as at 55, the number of annuity periods in years as at 56, and the social security index target benefit multiplier as at 57. In one embodiment of the invention, the user can have the evaluator component consider the effect of additional annual contributions as at 58 beyond the grantor's initial contribution, which is identified at 59. The present invention can also consider the social security income (SSI) benefit index identified at 60 to help the grantor decide what defined contribution plan will help the individual reach a stated goal. Information such as the current maximum monthly individual SSI benefit can be obtained through financial database 46 in FIG. 1. The present invention can further consider an initial pre-birth investment into an investment account (e.g., an escrow account, tax-free investment (e.g., tax free money market or tax free municipal bond), tax-deferred investment or taxable investment (e.g., mutual fund)) and compute what will become the initial deposit into the trust account resulting from the deposit into the investment account, as described further below.

As shown further in FIG. 2, if the grantor in this example provides an initial lump sum contribution of $17,210.36 and twenty-two annual additional contributions of $500, then the lump sum benefit to the minor in sixty-two years will be $1,534,386 as shown at 61, given the assumptions illustrated at 51-59. This lump sum benefit can also be broken down according to estimated annual annuity benefits 62 or estimated monthly annuity benefits 63 based on the estimated annuity period of twenty years shown at 64. The estimated future monthly SSI benefit is also shown at 65.

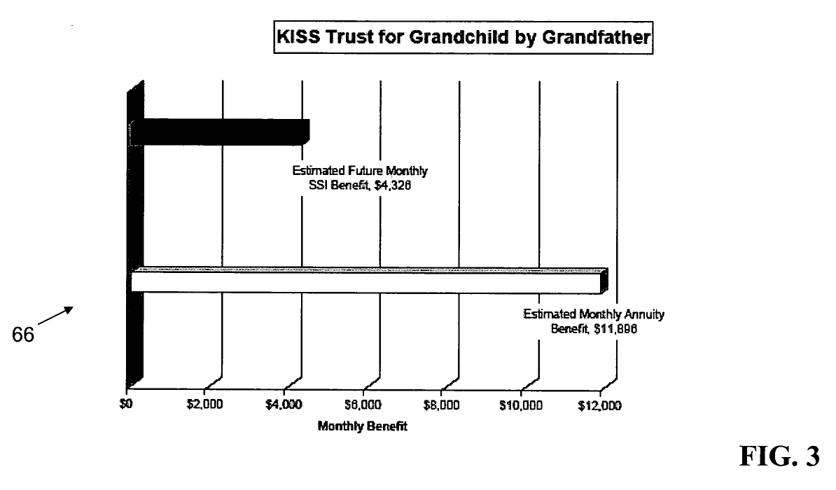

By providing this information to the user, the user can determine how much he or she needs to contribute initially (either directly via the trust or indirectly via the investment account) as well as annually (or on some other regular basis) in the form of ongoing contributions in order for the beneficiary to reach a certain lump or annuitized target. The present invention can also track tax information through database 46 in order to advise on how much the grantor may give as a tax free gift during any particular year. Graphical illustration component can provide various graphical representations for evaluation component to use in presenting results to users, such as the bar graph 66 shown in FIG. 3.

Evaluator component can operate to assist the user regardless of target goal metric. For example, if the user has a target goal for a future lump sum (e.g., $2 million), the present invention allows the user to modify parameters and assumptions accordingly. The user can also set a target goal based on a future annualized annuity or a future monthly annuity, for example. Additionally, the present invention allows the user to see the effect of particular defined contributions, whether the contribution is a single lump sum or a lump sum with a follow on of regular contributions.

It will be appreciated that, due to the investment being for a yet-to-be-born individual, the trust investment option or selection would not include or be possible through a tax-deferred 401 (k), IRA, SEP-IRA or even a pre-taxed Roth IRA, for example, because such vehicles require that the beneficiary be employed and have earned income. Thus, the investment option or selection cannot require that the beneficiary be employed and have earned income. Further, the trust investment option cannot include an investment option which includes an asset that can be consumed pre-retirement, such as a gift provided under the Uniform Gifts to Minors Act (UGMA), which can be controlled by a minor at age 18, for example. In addition, the investment option cannot include an asset that can be attachable by creditors, such as something which may be considered community property should the beneficiary marry later in life and then become divorced. Any community property in such divorce situations would be exposed to the ex-spouse; however, the present invention does not allow for this eventuality by providing investment options which cannot be considered community property and therefore subject to attachment by an ex-spouse, for example.

In one embodiment, the present invention can operate so that any investment options or selections involve assets that grow tax-deferred while not requiring the beneficiary to be employed or have earned income. IRAs and 401 (k)'s allow assets to grow tax-deferred, but such vehicles also require that the individual be employed and have earned income. The present invention can allow the assets to grow tax-deferred without requiring that the beneficiary be employed or have earned income, thereby truly providing a system and method for facilitating the funding and administration of a long term investment or retirement trust for the benefit of a yet-to-be-born individual. Once born, the child benefits because the assets are not attachable by creditors. The now-born child further benefits by being a beneficiary of a tax-deferred investment without having to be employed or have earned income.

In one embodiment of the invention, investment options (whether pre- or post-trust creation) can be provided through database 48 in the form of mutual funds, or one or more funds of funds, for example. Mutual funds are investments that typically invest in stocks, bonds, money market instruments, or some combination of the three. A fund of funds is an investment fund that divides up its investments among multiple other funds, as opposed to individual stocks, bonds or other investments. A fund of funds can provide a means for greater diversification for investors. If deemed an acceptable risk, grantors can also select hedge funds as their investment option.

In another embodiment of the present invention, investment options are provided through database 48, for example, according to the age of the beneficiary, wherein a plurality of age bands are provided with associated recommended investment option selections. For example, the present invention can include five age bands with different investment options and different investment option recommendations, with the first age band being associated with individuals aged 0 to 24 years, for example, the second age band being associated with individuals aged 25 to 34, for example, the third age band being associated with individuals aged 35 to 49, for example, the fourth age band being associated with individuals aged 50 to 64, for example, and the fifth age band being associated with individuals age 65 and over, for example. Of course, alternative numbers and ranges of age bands can be used.

It is contemplated that the present invention can allow for automatically adjusting investment and/or portfolio selections from the beginning to the end of the investment. For example, a grantor providing funds for a yet-to-be-born individual may elect to have the investment automatically managed as the child (once born) progresses through various age ranges or bands. In this example, the system of the present invention can provide for a standardized approach based upon beginning with more aggressive growth investing during the early years, for example, to more predictable and conservative investing during the later years. As the beneficiary reaches each successive age band, the present invention can automatically move the invested funds to a new selection corresponding to the available investment option(s) for the next age band. This provides for a “set it and forget it” approach to funding for grantors in connection with the present invention. In one embodiment of the present invention, the investment options component can include programming for automatically determining one or more investment options for each of the age bands from among a plurality of available investment options.

It will be appreciated that the grantor and beneficiary are not required to rely upon the system of the present invention to select among one or more available investment options, whether the options are associated with a given age band or not. For example, one or more investment options can be selected by a trust creator or grantor at the time a trust or investment vehicle is created, with one or more investment options subsequently selected as replacement selections for the initially selected investment option(s) by the grantor. As another example, one or more investment options can be selected by a trust beneficiary or investment account holder at the time a trust or account is created, with one or more investment options subsequently selected as replacement selections for the initially selected investment option(s) by the beneficiary in the future.

In addition to the components described above, the investment modeling and management system 12 also provides a trust creation (TC) component 40 and a financial account creation (FAC) component 41. These components provide for the real time production of one or more trust documents and/or investment accounts necessary and specific to the ultimate purpose of establishing a funded pre-retirement trust for a minor child (once born or yet-to-be-born), for example. The TC component allows the user, such as a grantor, to generate and establish trust documentation based on, for example, a desired option presented to the user using evaluation component. If the child is yet-to-be born, the trust documentation can be sufficiently pre-established such that it is “ready to go” once the child is born. Once the trust documentation is pre-established and once the child is born, the grantor or other user can add any missing trust document information (e.g., name, SSN) and fund the trust. The deposit/withdrawal component 42 can be used to fund (1) the pre-trust escrow or other investment account for the benefit of the yet-to-be-born individual, and (2) the trust account once the child is born. In one embodiment of the present invention, deposit/withdrawal component 42 is notified by the TC component once the child is born and thereafter initiates the establishment of the previously set up trust account, funding the trust account via automatic transfer of funds from the investment account. In another embodiment of the present invention, deposit/withdrawal component 42 is provided externally to investment processing and management system 12 and is tied directly to a financial institution such as a trustee bank or trustee insurance company, for example. Once the trust and initial funding are established, the trust terms and documentation can be stored in the database 44 for trust and investment selections.

As alluded to above, with yet-to-be born individuals, it is generally not be possible to proceed directly with trust creation because there is no known beneficiary; in such cases, an escrow account, mutual fund, tax-free, tax-deferred or other financial vehicle can be set up using FAC component 41, wherein the account can be for the benefit of the unborn individual (e.g., Mr. I. M. Generous (grantor) escrow account for the benefit of unborn baby Generous). At the time of creation of the account, there is likely no name, social security number or date of birth information for the as yet unborn child; however, other trust provisions can be input (i.e., pre-established) via TC component 40. After the child's birth, the system of the present invention allows the grantor to access the trust documentation via interface 32 and TC component 40 so as to enter in the final name, social security number and/or date of birth, as well as to review, modify or add to previous trust design elements, to thereby finalize the trust document. The trust can thereafter be produced and issued. The TC component and the FAC component can communicate with one another and the user can interface with both components at the same time. In this way, the initial pre-establishment of trust terms and the financial account creation can be managed at the same time, such that when the beneficiary is later born, the management of funds transfer from the financial account (e.g., escrow account) to the trust account is simplified. In one embodiment of the present invention, once the child is born and the investment account funds are due to be transferred to the trust account, the deposit/withdrawal component 42 communicates with the investment account bank or holding entity so as to initiate an electronic funds transfer (e.g., Federal Reserve wire) to the trust account.

In one embodiment of the present invention, the interface 32 and TC 40 components of the system of the present invention can collect the expected due date of the child-to-be-born at the time the account is initially created, including one or more pre-established calendar points after the expected due date in which to send follow up notices and reminders (e.g., e-mails). Such functions can be provided through a trigger notification component of the TC, in accordance with one embodiment of the present invention. The TC component 40 can further assign a unique id and url for each escrow account that provides the ability for the user (e.g., grantor) to connect and/or log on after the child's birth and input the remaining required information to finalize the trust. The TC component can then issue the trust for signature, whether by mail, electronic mail or otherwise. In one embodiment of the invention, an electronic signature from the grantor is sufficient to finalize the trust creation. Funding of the trust can be handled automatically as described above through deposit/withdrawal component. In an alternative embodiment of the present invention, the investment account funds can be sent via check to the grantor, after which the grantor can deposit the funds into the trust account. At any time prior to the trust creation, the grantor may allow a refund and/or cancellation option in the event the grantor has a change of mind, or if the birth is unsuccessful or otherwise.

It will be appreciated that the present invention can accommodate individual gifts as well as a series of contributions (even from dissimilar parties) into the escrow account. The funds in the escrow account are ultimately gifted into the trust upon creation of the trust. In one embodiment of the present invention, the system operates so as to deposit the account proceeds in a tax-free money market account or similar liquid account, allocating the tax free interest via an omnibus accounting system that tracks each unborn child's account interest, for example. In another embodiment, each gift would result in the creation of a separate escrow account. The present invention can be employed during or even before pregnancy, even years in advance of anticipated pregnancy.

In another embodiment of the present invention, a gift account registry can be provided through FAC component 41 in order to allow would-be grantors to contribute to the trust and/or account of the yet-to-be born individual. Such a gift account registry can be used by parents, grandparents, other relatives, friends, anonymous gift givers and any other individuals desiring to provide a monetary gift to the unborn individual. In one embodiment of this aspect of the present invention, gifts can be provided via online interface for registered users, while gifts can be provided via credit card, check or ACH transaction for unregistered users. Messaging and communications can be provided as desired and/or required, including email and/or hard copy notification of gifts received to the prospective parent of the yet-to-be born child. In one embodiment, the parent-to-be can use the system of the present invention to select from several different formats of registry announcements for distribution to friends, family and other would-be gift providers. Such announcements can be issued from the system of the present invention via standard mail with a return envelope for holding contributions such as checks, for example. In such a scenario, the present invention can pre-print the account and/or trust unique identifier on the announcement in order to facilitate later processing.

It will be appreciated that the present invention can accommodate external systems communicating with deposit/withdrawal component 42 to facilitate seamless transaction processing. For example, if a grantor is a member of an affinity program, a computer system associated with the affinity program can communicate with modeling and managing component 12 in order to allow the grantor to direct affinity membership (financial) rewards into the investment. Similarly, round-up programs, which allow consumers to deposit change left over from a transaction into an account, can tie in to the deposit/withdrawal component to allow grantors to direct round-up money into the investment. Other programs such as vendor rebate programs, Section 529 or other college savings programs can similarly be interfaced with the deposit/withdrawal component 42. Additionally, employers can interface with the present invention in order to fund employee trusts (e.g., for the employee's children) through an employer matching or similar such program.

In one embodiment of the present invention, an insurance funding vehicle can be provided with an interface to the system of the present invention, in order to fund the trust and/or investment using funding from an insurance vehicle. This can include funding associated with a life insurance contract, or an annuity such as an individual annuity, group annuity or variable annuity. A variable annuity is a contract between a beneficiary and an insurance company, under which the insurer agrees to make periodic payments to the beneficiary either immediately or at some time in the future. The grantor can purchase the variable annuity contract either with a single lump sum or by a series of purchase payments over time. The investment options for a variable annuity can be mutual funds or a fund of funds, for example. Variable annuities differ from mutual funds in that a variable annuity (1) has a death benefit (if the grantor dies before the insurer has started making payments, the beneficiary is guaranteed to receive a specified amount—typically at least the amount of the purchase payments); (2) allows the beneficiary to receive periodic payments for the rest of his or her life; and (3) is tax-deferred.

In another embodiment of the present invention, loan details can be inputted via the system interface 32 in order to allow loan proceeds to be used as funding for the trust and/or investment. In a particular embodiment of the present invention, the computer system for administering the trust is also capable of administering the loan vehicle. This can be through tracking component 45 or another system component, for example. Administration of the loan vehicle can include obtaining a loan application from a loan provider, presenting the loan application to the trust beneficiary, obtaining a signed loan application, presenting the signed application to the loan provider, receiving funds from the loan provider, and transferring the funds to an account of the beneficiary (e.g., the trust). In one embodiment of the present invention, the loan proceeds can be derived from a life insurance contract (for example, where the grantor takes a loan from the cash value of the insurance contract). In one embodiment of the invention, the loan management capabilities of the present invention can assist a grantor who wants to provide funds in an amount greater than would be allowable tax-free under the applicable gift tax. For example, if grantor A wishes to provide $50,000 in funding at one time to an account that will later be transferred to a trust for the benefit of A's granddaughter (once born), A may be limited by tax considerations to a tax-free gift of $24,000 (assuming A is married and the gift is a joint gift). A may still be able to provide the $50,000 to the trust, as long as the $26,000 that would ordinarily be taxable is provided as a loan. Interface 32 can handle gift donations and loan proceed donations at the same time, and can filter the separate amounts through deposit/withdrawal component 42. Thus, grantor A can use the gift vehicle interface and loan vehicle interface for depositing a single fund investment with the trust. Further, the grantor can designate the amount of the single fund that is a gift and the amount of the single fund that is a loan.

In creating trusts via TC component 40, the present invention can receive one or more of the following input variables, by way of example and without limitation: (1) Grantor Data (including name, address, SSN and other contact details (collectively, “identification data”)), (2) Beneficiary identification data (to the extent known if the beneficiary is a yet-to-be-born individual), (3) Guardian identification data, (4) Co-Trustee identification data and (5) Terms. In one embodiment of the present invention, the terms can include, for example, (a) the minimum age that the beneficiary (once born) may start receiving the benefit, (b) whether a lump sum benefit will be an allowable option (c) a Crummey Power Election, (d) the age at which the beneficiary may direct investment choices, (e) investment restrictions, and (f) whether an outside investment advisor will be permitted, in which case the name, address and other pertinent identification data of the outside investment advisor will be collected.

In one aspect of the present invention, TC component 40 includes an alternative distribution options selection component (not shown). Instead of the distribution being made to the beneficiary upon retirement, the grantor can elect to have assets distributed to the beneficiary at certain milestones during the minor child's later life. This selection can be received by the alternative distribution options selection component of the trust creation component. For example, the distribution options selection component can receive selections for distribution options such as (1) post-secondary tuition payments (e.g., college education, room and board, tuition expenses); (2) age attainment payments, such as at ages 25, 30 and/or 35, the beneficiary is to receive x %, or $x of the assets, principal or income in the trust (potentially subject to a designated maximum distribution percentage); and (3) first time principal residence purchase payments, which can be used to help fund a down payment on a first time home for the beneficiary. Other types of non-retirement payments from the trust funds can be accommodated. The available options can be stored within a database accessed by the alternative distribution options selection component.

The distribution options selection component can provide various rules that govern the grantor/settlor's selection of alternative distribution options. For example, in connection with the post-secondary tuition payments, distribution can be restricted such that it is only made upon receipt of a written request from the beneficiary evidencing a tuition payment obligation supported by a valid receipt, bill or statement from an accredited school of higher education. Further, a rule may require that no distribution is to be made with respect to any prior tuition obligations. Another rule may require that the distribution be made in increments of ten percent (10%) of the then value of the trust assets (e.g., rounded to the next highest $1,000), except that the minimum distribution shall be, for example, $5,000.00 or the total account balance, whichever is less. Time limit rules may also apply. For example, a rule can state that distributions for college and post-secondary tuition of the beneficiary shall only available for so long as a valid request is received prior to the beneficiary not obtaining the age of 30.

In connection with the age attainment distributions, other rules may apply. For example, one rule may require that distribution only be made upon receipt of a written request form as approved for use by the trust administrator, from the beneficiary upon attaining the specific age. Another rule in this scenario may require the distribution to be made in increments of, e.g., ten percent (10%) of the then value of the trust assets (e.g., rounded to the next highest $1,000), except that the minimum distribution shall be, for example, $5,000.00 or the total account balance, whichever is less. Another rule may further state that the maximum distributions percentages are applied individually and are not cumulative.

In connection with the first time residence purchase, other rules may be applied. For example, one rule may require that distribution only be made upon receipt of a written request from the beneficiary evidencing the first time purchase of the principal residence. Another rule may require that the distribution be made in increments of, e.g., ten percent (10%) of the then value of the trust assets (e.g., rounded to the next highest $1,000), except that the minimum distribution shall be $10,000, for example.

For all of the alternative distribution selection options, a global rule can be implemented that any such distributions must meet with the approval of the trust administrator.

As further shown in FIG. 1, investment modeling and management system 12 can further be provided with a tracking/reporting component 45, which assists users such as trustees, trust administrators or overseers in tracking the performance and credit rating of insurance carriers, trust assets, investments, and trust laws, for example. If the credit rating available from Moody's, Fitch or other rating agency for an annuity provider (e.g., an insurance carrier) drops, the trust administrator may choose to notify the family trustee with possible recommendations for substitutes for the trustee's consideration. If the trustee wants to change the carrier, or redirect any investments, for example, the trustee can notify the trust administrator. In one embodiment of the present invention, the selected investments from the trust database 44 can be compared to other investment opportunities searchable through external database 48. In another embodiment of the present invention, the administrator or other user can track the trust laws pertaining to the situs of the trust. For example, if Maryland is the situs of a particular trust and the administrator discovers that the Maryland trust laws have changed to be less advantageous for grantors, beneficiaries or the trust itself, the administrator can then direct or recommend that a new trust be generated with a new situs using trust creation component 40. In one embodiment of the invention, changes in trust laws are automatically recorded by the present invention and automatic notices to trust administrators affected by such changes are provided via reporting component 45.

With regard to credit rating agencies, it will be appreciated that the present invention can provide a mechanism whereby the disparate rating options of two or more commonly known rating agencies, such as Moody's, Fitch, Standard & Poor's, for example, can be aggregated into a new, combined rating scale. By doing so, the present invention can simplify the evaluation and presentation of the ratings, as well as that of the products being rated.

The investment modeling and management system 12 thus provides for the real-time, interactive modeling for the pre-funding of an investment account or retirement benefit account for a yet-to-be-born individual or other beneficiary. The present invention can assist regardless of investment goal and approach. For example, for a defined indexed targeted benefit, the evaluator component of the present invention can present a calculation and graphical representation of a single lump sum contribution funding required to create: (1) a targeted lump sum retirement benefit (based on today's dollars and adjusted for a stated inflation index factor), (2) a targeted annualized annuity retirement benefit (based on today's dollars and adjusted for a stated inflation index factor), or (3) a targeted monthly annuity retirement benefit (based on today's dollars and adjusted for a stated inflation index factor).

The input used in the above approach can include, for example, the amount of targeted of lump sum benefit (in today's dollars) desired, target benefit inflation index factor, number of benefit periods desired, minor child's age at funding, amount of additional contributions, number of additional funding contributions, pre-retirement interest rate assumption, post retirement interest rate assumption, and targeted age of the beneficiary's retirement age.

For a defined indexed targeted benefit with additional contributions, the evaluator component of the present invention can present a calculation and graphical representation of a defined initial lump sum contribution and a specified number of additional funding contributions to create: (1) a targeted lump sum retirement benefit (based on today's dollars and adjusted for a stated inflation index factor), (2) a targeted annualized annuity retirement benefit (based on today's dollars and adjusted for a stated inflation index factor), or (3) a targeted monthly annuity retirement benefit (based on today's dollars and adjusted for a stated inflation index factor).

The input used in the above approach can include, for example, the amount of targeted of lump sum benefit (in today's dollars) desired, target benefit inflation index factor, number of benefit periods desired (maximum of one), minor child's age at funding, amount of additional contributions, number of additional funding contributions, pre-retirement interest rate assumption, post retirement interest rate assumption, and targeted age of the beneficiary's retirement age.

It will be appreciated that the present invention operates using appropriate security and authentication mechanisms to prevent fraudulent or otherwise improper activities. In one embodiment of the invention, each user is provided with at least a user name and password which are required in order to log in to use the invention via computer or other remote electronic device. Other security and authentication mechanisms can be employed as are known in the art, including biometric identification technique and/or public key infrastructure (PKI), for example.

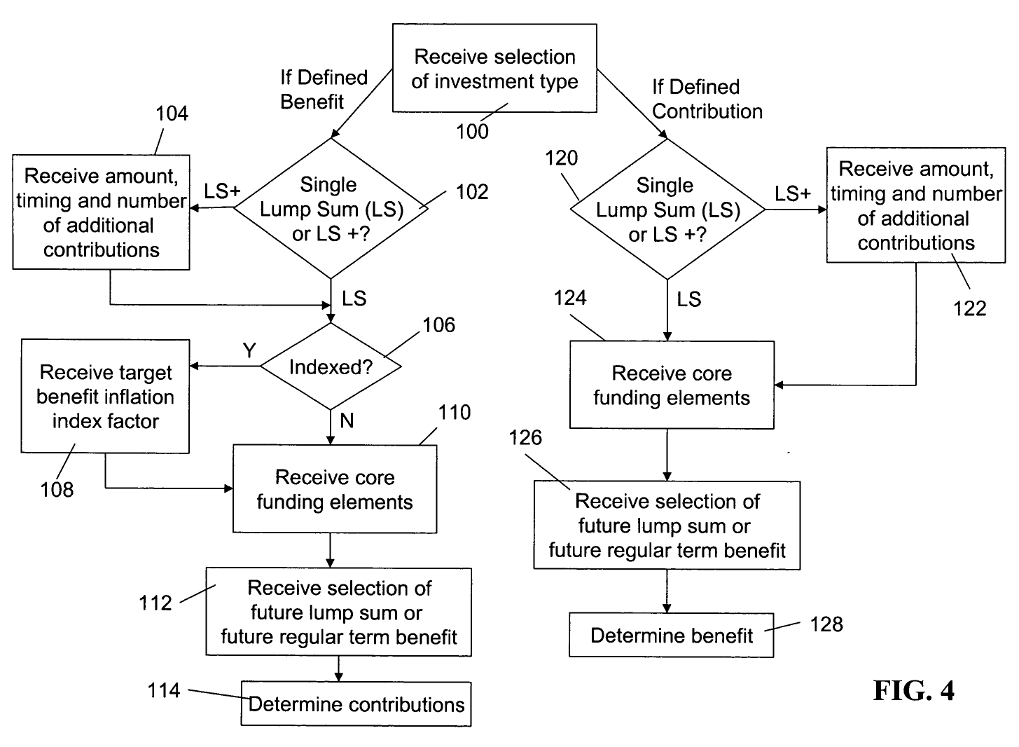

FIG. 4 shows a sample flow chart illustrating method steps in accordance with various aspects of the present invention. At step 100, the present invention receives from the grantor a selection of the grantor's preferred investment type for the trust that will ultimately come into effect after the birth of the yet-to-be-born individual. If the grantor selects the defined benefit approach, then the grantor is queried as at 102 for whether he or she would like to view options pertaining to a single defined lump sum contribution (e.g., grantor would like to invest $20,000 all at one time with no further payments) or a single defined lump sum contribution plus additional periodic contributions. If the user determines that he or she would like to see options with additional periodic contributions, the user is queried to provide, and the system receives, information regarding the number, timing and amount of additional funding contributions as at 104. Once this information has been received, or if the user selects only a single lump sum contribution at step 102, then the system receives from the user an indication of whether the user would like to see indexed options (e.g., a benefit based on today's dollars and adjusted for a stated inflation index factor) as at 106. If so, then the system receives from the user a target benefit inflation index factor as at 108. Once this information has been received, or if the user does not desire to receive indexed option information, then the system of the present invention receives core funding elements as at 110. Such elements can include, for example, the amount of a targeted lump sum benefit (which can optionally be in today's dollars), the amount of a targeted annualized annuity benefit (which can optionally be in today's dollars), the amount of a targeted monthly annuity benefit (which can optionally be in today's dollars), a number of benefit periods desired (e.g., pay for 20 years), an age of the beneficiary at the time of funding, a pre-retirement interest rate assumption, a post retirement interest rate assumption, and/or a targeted age of the beneficiary at retirement. At step 112, the invention can receive a selection from the user regarding whether the determination is to be made based on a future lump sum benefit or a future regular term benefit (e.g., a periodic payment such as every month for 20 years, every year for 20 years, etc.). At step 114, the present invention can process the received data in order to calculate and determine contributions that would be required to meet the inputted criteria. The calculations and determination can be presented in a report or graphically, for example, as described above.

Referring again to FIG. 4, if the user at step 100 desires to determine the projected results of defined contributions to a particular retirement or investment plan, the user can be queried, as at step 120, for whether the defined contribution would be a single lump sum or a lump sum plus additional contributions. If the latter, then the user would provide information as to the amount, timing and number of additional funding contributions as at 122. Once this has been received, or if the user selected a single lump sum contribution, then the present invention would receive core funding elements as at step 124. Such elements can include, for example, the amount of a single lump sum contribution, a number of benefit periods desired (e.g., pay for 20 years), an age of the beneficiary at the time of funding, a pre-retirement interest rate assumption, a post retirement interest rate assumption, and/or a targeted age of the beneficiary at retirement. At step 126, the invention can then receive a selection from the user of a future lump sum benefit or a future regular interval payment. Alternatively, at step 126, the invention can receive a selection from the user of an alternative distribution option as described above. At step 128, the present invention can process the received data in order to calculate and determine contributions that would be required to meet the inputted criteria. The calculations and determination can be presented in a report or graphically, for example, as described above.

It will be appreciated that, while the above steps have been described in accordance with one method of the present invention, the steps can occur in a different order without necessarily affecting the outcome of the invention's determination. For example, the user can input a response to the indexed selection option prior to a response to the lump sum versus lump sum plus additional payments option. Additionally, it will be appreciated that the present invention can incorporate logic to facilitate accuracy of information receipt and investment calculations by restricting what fields can be accessed according to user selections. For example, if a user desires that the present invention determine a defined lump sum benefit to a beneficiary based on a single lump sum investment, then the field that would ordinarily accept information pertaining to the number of benefit periods would not be accessible. This is because a defined lump sum benefit would only be distributed once, and there would be no need for a user to enter a number of benefit periods. Further, if the user desires to know approximately how much to invest in a pre-trust account (e.g., an investment and/or escrow account) for a yet-to-be born individual, wherein the user intends to use the investment/escrow account to fund the trust at a later time, the evaluator 34 of the present invention can consider various rates of return, administrative expenses, roll-over consequences and other factors to present the user with an estimated initial deposit to be provided to the non-trust account in order to achieve the desired initial trust account deposit in the future. For example, if the user determines that the initial trust deposit in 10 months should be $12,500, then the user may find through evaluator component 34 that the user should deposit $11,900 in the pre-trust account so that the required amount of $12,500 in ten months is likely to be available.

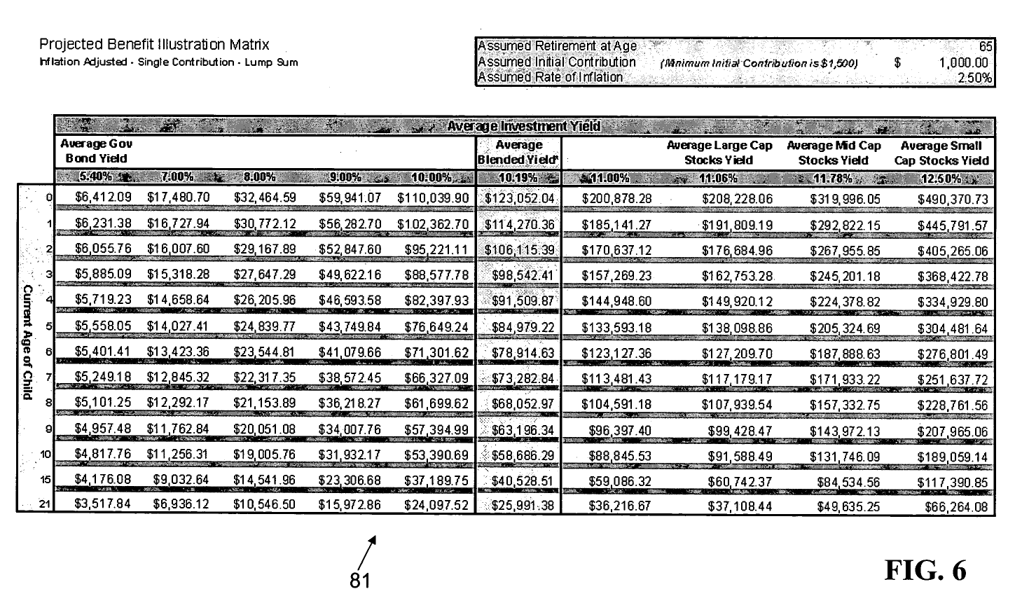

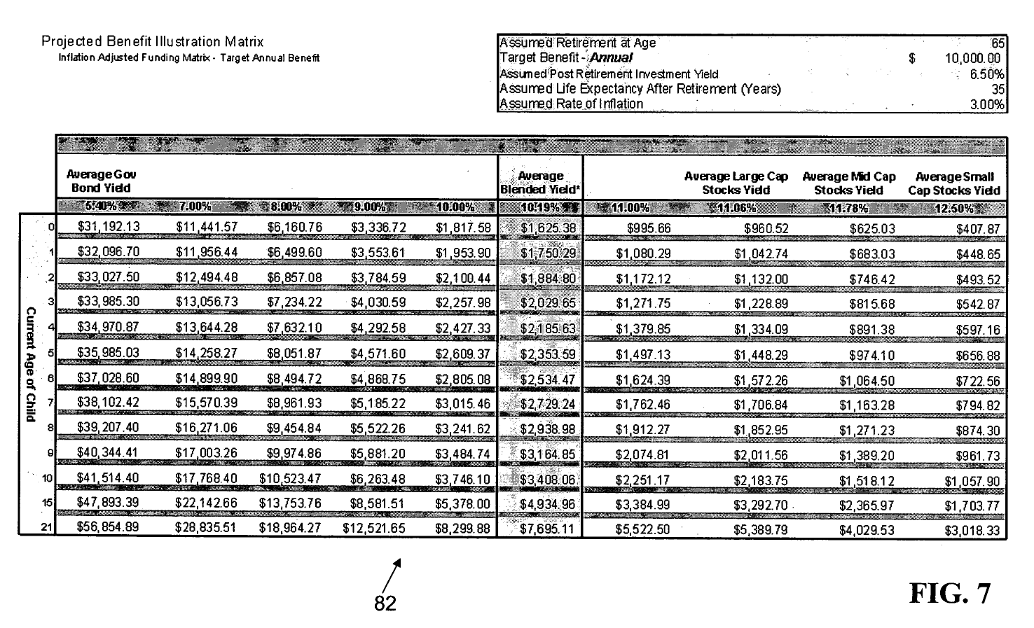

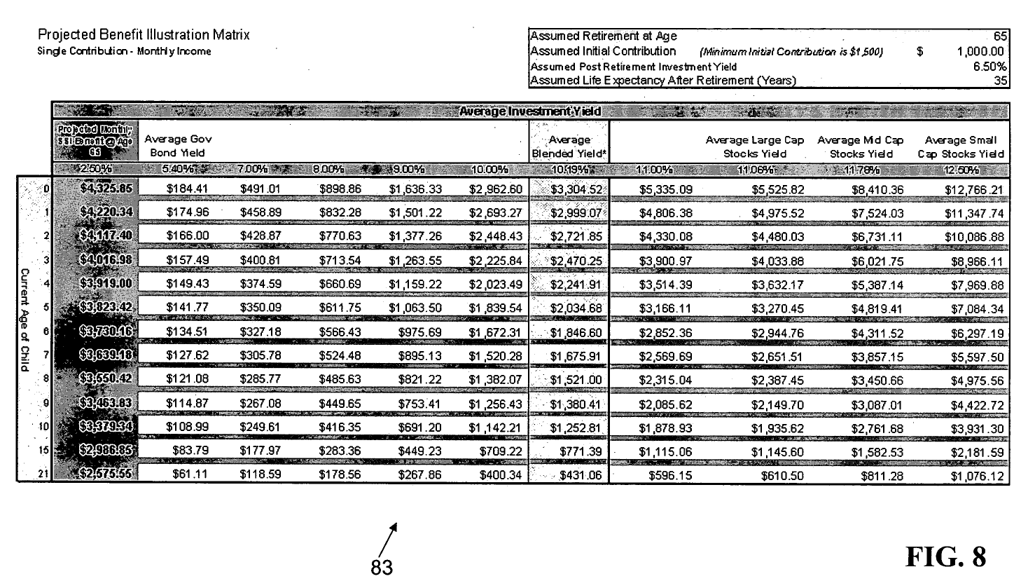

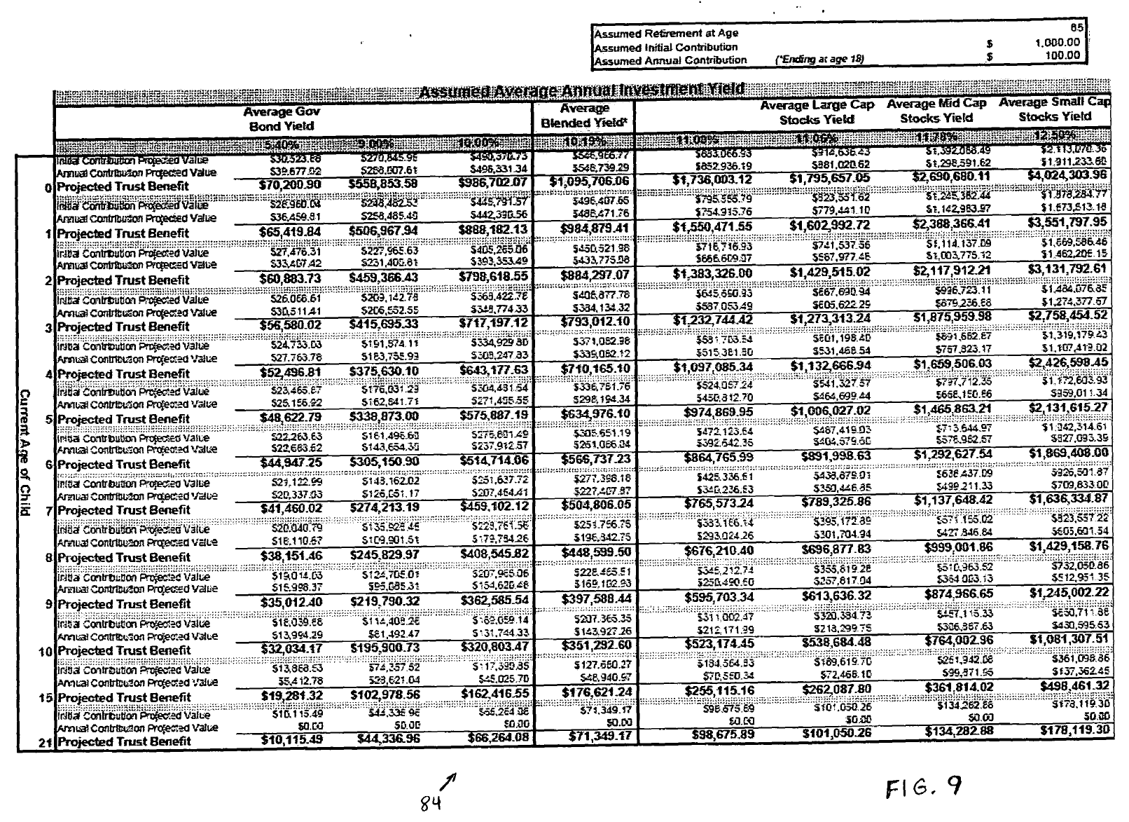

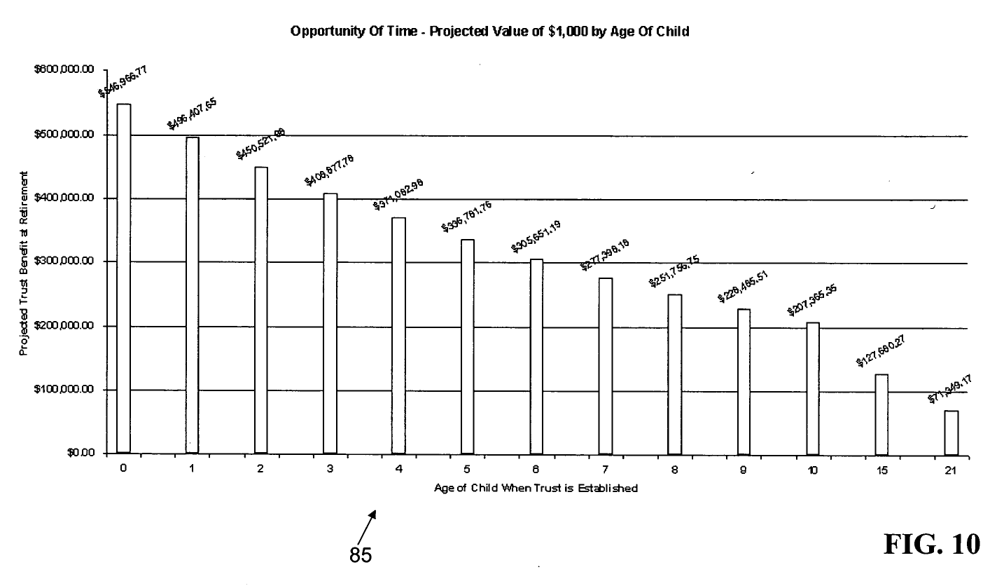

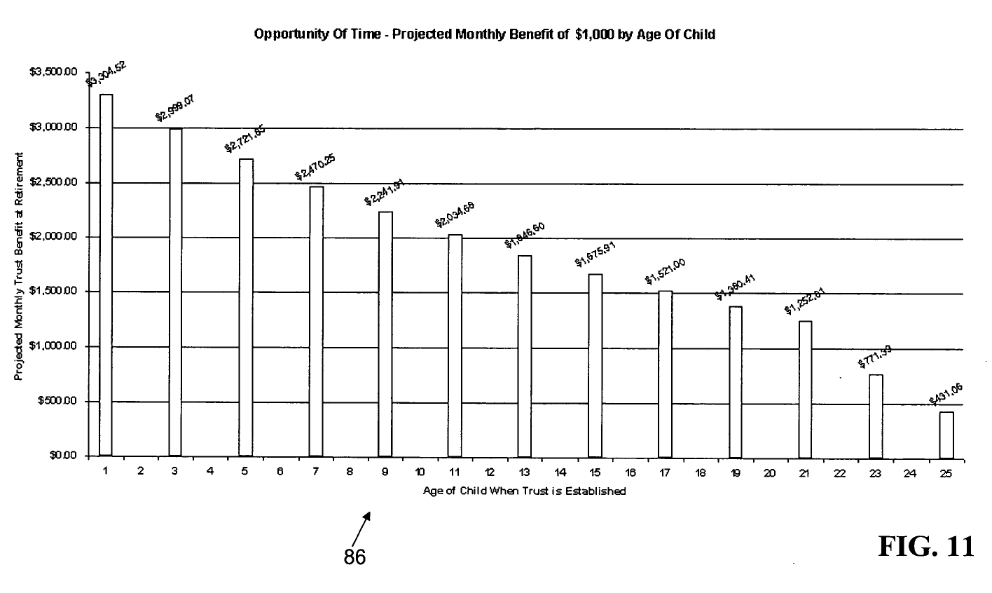

Various reports or graphical displays can be provided in accordance with the present invention. For example, FIG. 6 shows a tabular display 81 in the form of a projected benefit matrix, illustrating a projected lump sum benefit, inflation adjusted, based on a single contribution made at a given age and at different average rates of return. FIG. 7 is a sample display 82 showing projected benefit for a target annual benefit of $10,000 to begin at age 65 and continue for 35 years, adjusted for inflation and based on a single contribution made at a given age and at different average rates of return. FIG. 8 is a sample display 83 showing projected monthly benefit for a single contribution made at a given age and at different average rates of return. FIG. 9 shows a sample display 84 showing projected lump sum benefit for a single initial contribution with annual additional contributions made beginning at a given age and at different average annual rates of return. FIG. 10 shows a sample display 85 showing projected value over time of a $1000 gift depending upon the age of the child beneficiary when the gift is made, assuming a certain rate of return. FIG. 11 shows a sample display 86 showing projected monthly benefit at retirement of a $1000 gift depending upon the age of the child beneficiary when the gift is made, assuming a certain rate of return. Each of the displays in FIGS. 6 through 11 can be adapted in order to accommodate yet-to-be-born beneficiaries.

Reports can be sent regularly to the interested parties. In one embodiment of the present invention, reports are sent on an annual basis, thirty days before the birthday of the child, showing the current balance and the forecasted future values, assuming the same historical average rate of return is achieved. The reports can also illustrate the impact of small additional contributions (such as adding $100, $250 and $500 a year until age 18) in order to provide an incentive for grantors to provide additional trust funding.

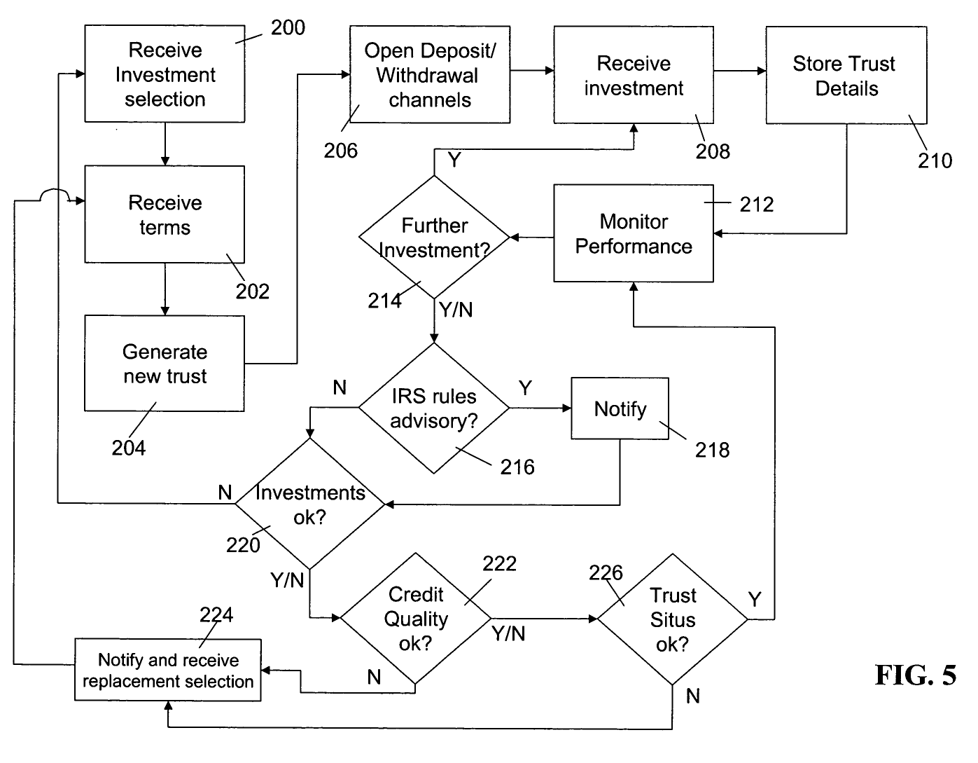

FIG. 5 shows a sample flow chart illustrating method steps in accordance with trust generation aspects of the present invention. As shown in FIG. 5, the present invention can receive an investment selection as at 200 from a user such as a grantor who wishes to establish a retirement trust for a yet-to-be-born individual, for example. In one embodiment of the invention, the grantor will have already run one or more investment scenarios using the evaluator component of the present invention and decided upon an appropriate investment arrangement. As described above, the present invention provides a system that seamlessly allows the user to run different investment scenarios and then generate a trust based on a desired scenario in real time. After receiving the investment selection, the invention receives the terms of the trust as at 202, including such elements as (1) the identification data for the grantor, beneficiary, guardian (if any) and co-trustee (if any), (2) minimum age for the beneficiary to start receiving benefit, (3) allowance of lump sum benefit, (3) Crummey power election, (4) age in which the beneficiary can direct investment choices, (5) investment restrictions, and (6) whether an outside investment advisor is permitted and, if so, that advisor's identification data. The terms received can also include any alternative distribution options selected by the grantor as described in the examples above. At step 204, the present invention generates a new proposed trust via TC component 40.

At step 206, the present invention opens the appropriate funding channels, including, for example, a channel to allow the grantor to deposit funds directly from other accounts, an affinity program channel (if any), a round-up program channel (if any), a vendor rebate channel (if any) and any other channels which may be necessary to allow funds to flow properly and simply into/out of the trust or investment vehicle. The funding channels can be established according to the terms of the trust, for example. At step 208, the initial investment is received, and at step 210 the trust details are stored such as in trust database 44 (in FIG. 1).

Once in effect, the trust performance and other characteristics affecting the trust are then continually and regularly monitored as at 212. If further investment is forthcoming at 214, whether by outside program or according to the regular additional trust deposits previously arranged for, the investment is then received by the trust back at step 208 and the details recorded. Whether or not further investment is received, the monitoring component will also check to see if an IRS rules advisory notification is in order as at 216. In one embodiment, the present invention allows the user to test and administer contributions by the grantor and notify the grantor when such contributions exceed Internal Revenue Service (IRS) non-taxable gift limits. The present invention can also notify the grantor of IRS gift limits necessary to avoid gift tax liabilities. Such notifications occur as at 218. Whether or not a notification occurs, the monitoring component will also check to see whether the trust investments are performing satisfactorily as at 220. Such evaluation can be based on trust definitions, a review by the grantor, administrator, overseer, beneficiary or the optional outside advisor, for example. If the performance is not deemed satisfactory, then new investment selections are received at step 200 and the full process flow begins again.

Whether or not the investments are acceptable, the monitoring component will also monitor the credit quality of the insurance company which underwrites an annuity held in trust as at 222, for example, as specified in the trust document being administered. This monitoring can be initiated by the administrator in one embodiment of the present invention. The present invention also allows the user to establish and maintain a database of the third party credit and financial rating organizations credit quality scores as specified in the trust document being administered. The present invention further allows the user to identify any insurance carrier dropping below the credit quality criteria as specified in the trust document being administered. In another embodiment, the present invention provides for reports to the trustee where an insurance company has failed to maintain the minimum credit quality criteria as specified in the trust document being administered. The present invention can further provide for the production of an annual hard copy report of the grantor, beneficiary, guardian of the beneficiary, trustee and co-trustee demonstrating the history of the third party credit quality scores. The present invention can also provide for the production of a hard copy and email notification by the trustee to the grantor, beneficiary, guardian of the beneficiary, and co-trustee the condition where an insurance company has failed to maintain the minimum credit quality criteria as specified in the trust document being administered.

All such notifications occur as at step 224, and the present invention also allows the grantor, beneficiary, or guardian of the beneficiary to elect to make a tax free exchange of the existing annuity for a replacement annuity where an insurance company has failed to maintain the minimum credit quality criteria as specified in the trust document being administered. In such cases, the process returns to the step of receiving the trust terms as at 202 and generating the new trust as at 204.

Whether or not the credit monitoring results are unsatisfactory, the monitoring component of the present invention also provides for the monitoring of state laws to determine whether the trust situs is acceptable at 226 as described above. If not, proper notifications are sent, and a selection of a replacement situs can be received as at 224.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system. The present invention can further run on a variety of platforms, including Microsoft Windows™, Linux™, Sun Solaris™, HPIUX™, IBM AIX™ and Java compliant platforms, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed and desired to be secured by Letters Patent is:

1. A computer-implemented system for facilitating the establishment and funding of a long term investment or retirement trust on behalf of a yet-to-be-born individual, comprising:
a trust creation (TC) component capable of receiving a selection of an investment option in connection with future trust funds to be used for the benefit of a yet-to-be-born individual, the TC component further capable of pre-establishing trust terms for a trust to be created in the future for the yet-to-be-born individual; and
a financial account creation (FAC) component in communication with the TC component, the FAC component capable of receiving financial account funds for the benefit of the yet-to-be-born individual and establishing a financial account, wherein, at a determined time after the creation of the financial account, the TC component creates a trust based on the selected investment option using the financial account funds as the trust funds.

2. A computer-implemented system for facilitating the funding of a long term investment or retirement trust on behalf of a yet-to-be-born individual, comprising:
a trust creation (TC) component capable of receiving a selection of an investment option in connection with future trust funds to be used for the benefit of a yet-to-be-born individual, the TC component further capable of pre-establishing trust terms for a trust to be created in the future, the TC component further including a trigger notification component for identifying the future time to establish a trust based on the pre-established trust terms;
a financial account creation (FAC) component in communication with the TC component, the FAC component capable of receiving financial account funds for the benefit of a yet-to-be-born individual;
a trust administration computer system for administering the created trust; and
an interface to the computer system for receiving funding from a grantor.

3. The system of claim 2 wherein the TC component includes an interface for (i) allowing a user to select the pre-established terms for the future trust, and (ii) delivering a trust document to the user in order to obtain a signed trust document once the beneficiary has been born.

4. The system of claim 2 further including a deposit-withdrawal component for receiving funds from the grantor and transferring the funds to an account of the beneficiary.

5. The system of claim 2 further including an investment options evaluation component in communication with the FAC component, wherein the investment options evaluation component cannot determine at least one investment option which requires that the minor child be employed and have earned income.

6. The system of claim 2 further including an investment options evaluation component in communication with the FAC component, wherein the investment options evaluation component cannot determine at least one investment option which includes an asset that can be consumed by the minor child pre-retirement.

7. The system of claim 2 further including an investment options evaluation component in communication with the FAC component, wherein the investment options evaluation component cannot determine at least one investment option which includes an asset that can be attachable by creditors.

8. The system of claim 2 further including an investment options evaluation component in communication with the FAC component, wherein the investment options evaluation component can determine at least one investment option which includes an asset that grows tax-deferred while not requiring that the minor child be employed or have earned income.

9. A computer-assisted method for facilitating the funding of a long term investment or retirement trust on behalf of a yet-to-be-born individual, comprising the steps of:
providing a trust creation (TC) component for pre-establishing terms of a future trust to be for the benefit of a yet-to-be-born individual;
providing a financial account creation (FAC) component in communication with the TC for creating an escrow account to hold gifts provided and intended for the future trust; and
providing an interface to the TC and FAC components for receiving funding from a grantor.

10. A computer-assisted method for facilitating the funding of a long term investment or retirement trust on behalf of a yet-to-be born individual, comprising the steps of:
providing a trust creation (TC) component capable of receiving a selection of an investment option in connection with future trust funds to be received for the benefit of a yet-to-be-born individual, the TC component further capable of pre-establishing trust terms for a trust to be created in the future for the yet-to-be-born individual;
providing a financial account creation (FAC) component in communication with the TC component, the FAC component capable of receiving financial account funds for the benefit of the yet-to-be-born individual and establishing a financial account; and
at a determined time after the creation of the financial account, preparing a trust based upon the pre-established trust terms and funding the trust with the financial account funds.

11. The method of claim 10 including the further step of providing an investment options evaluation component in communication with the FAC component, wherein the investment options evaluation component cannot determine at least one investment option which requires that the minor child be employed and have earned income.

12. The method of claim 10 including the further step of providing an investment options evaluation component in communication with the FAC component, wherein the investment options evaluation component cannot determine at least one investment option which includes an asset that can be consumed by the minor child pre-retirement.

13. The method of claim 10 including the further step of providing an investment options evaluation component in communication with the FAC component, wherein the investment options evaluation component cannot determine at least one investment option which includes an asset that can be attachable by creditors.

14. The method of claim 10 including the further step of providing an investment options evaluation component in communication with the FAC component, wherein the investment options evaluation component can determine at least one investment option which includes an asset that grows tax-deferred while not requiring that the minor child be employed or have earned income.
